(19) United States
(12) Patent Application Publication
(10) Pub. No.: US 2024/0392654 A1
(43) Pub. Date: Nov. 28, 2024

(54) SYSTEM FOR RESERVOIR STIMULATION WITH EXHAUST STREAM CAPTURE

(71) Applicant: Schlumberger Technology Corporation, Sugar Land, TX (US)

(72) Inventors: Anna Beletskaya, Sugar Land, TX (US); Ryan Epp, Houston, TX (US); Konstantin Viktorovich Vidma, Sugar Land, TX (US); Roman Alexandrovich Skachkov, Quincy, MA (US); Christopher S. Daeffler, Sugar Land, TX (US); Richard L. Christie, Sugar Land, TX (US); Shahnawaz Hossain Molla, Watertown, MA (US); Glen Andrew Hay, Calgary (CA)

(21) Appl. No.: 18/676,028

(22) Filed: May 28, 2024

Related U.S. Application Data
(60) Provisional application No. 63/504,520, filed on May 26, 2023.

(51) Int. Cl. E21B 41/00; B01D 53/04; B01D 53/14; B01D 53/26

(52) U.S. Cl. CPC E21B 41/0057; B01D 53/0438; B01D 53/1425; B01D 53/1493; B01D 53/26; B01D 2252/20489; B01D 2253/108; B01D 2258/01

(57) ABSTRACT

A system for capturing a target species from an exhaust gas stream generated by at least one engine at a surface of a wellbore utilized in reservoir stimulation for subsurface energy recovery. The system includes a heat exchanging system for cooling the exhaust gas stream to a predetermined temperature. The system includes a water separation unit for separating a liquid from the cooled exhaust gas stream. The system includes a target species capture module for capturing the target species from the cooled exhaust gas stream. The system includes a target species regeneration module to extract the captured target species. The system includes a target species compression module for liquefying the captured target species. The system includes a target species storage module for storing the liquified target species, wherein the system is mounted on a mobile platform for transportation to and from the surface of the wellbore.

### CROSS-REFERENCE TO RELATED APPLICATIONS

This application claims priority to and the benefit of U.S. Provisional Application No. 63/504,520 filed on May 26, 2023. The aforementioned application is incorporated by reference herein in its entirety.

### BACKGROUND

### Field

The present disclosure generally relates carbon capture and storage at a wellsite.

### Description of Related Art

Hydraulic fracturing is one of the ways to stimulate hydrocarbon production from a subterranean formation penetrated by a wellbore. Hydraulic fracturing involves an injection of a large amount of fluid into the well at a pressure high enough to create fractures within the formation. The process is generally associated with a significant CO₂ footprint as the fracturing pumps are traditionally powered by diesel engine prime movers. Electric fracturing engines powered by natural gas through electricity generators or gas turbines are also associated with less, but a still significant CO₂ footprint. CO₂ is one of the gases causing the greenhouse effect, a gradual increase of global temperature which accelerated after the Industrial Revolution. In 2015 many countries signed an agreement to limit the increase of the global temperature to value under 2° C. by 2050 including steps toward decarbonizing various processes.

One of the approaches to decarbonize energy recovery operation, e.g., hydraulic fracturing, is the transition from the diesel-powered prime movers to electric equipment prime movers powered from a green or low carbon source of electricity but it may not be feasible within the short to middle term.

Application of Carbon Capture and Storage (CCS) technologies is an alternative solution to achieve the Paris agreement objective. CCS is a set of technologies intended to reduce the amount of CO₂ in the atmosphere. CCS systems have been primarily used in power plants because they are predominant point-source emitters of CO₂. As a result, existing CCS systems have been adjusted to the CO₂ emitters which are almost always in a stationary mode. Adaptation to the typical operating characteristics of oilfield equipment, (e.g. hydraulic fracturing pump), such as variation of the mass flow and concentration of species in the flue gas due to acceleration, decelerations, and engine loads, must be considered.

There is a need in the art to reduce the overall carbon footprint of the oilfield surface equipment and services.

### SUMMARY

In one aspect, a system for capturing a target species from an exhaust gas stream generated by at least one engine at a surface of a wellbore utilized in reservoir stimulation for subsurface energy recovery, comprising: a heat exchanging system for cooling the exhaust gas stream to a predetermined temperature; a water separation unit for separating a liquid from the cooled exhaust gas stream; a target species capture module for capturing the target species from the cooled exhaust gas stream; a target species regeneration module to extract the captured target species; a target species compression module for liquefying the captured target species; and a target species storage module for storing the liquified target species, wherein the system is mounted on a mobile platform for transportation to and from the surface of the wellbore.

In one aspect, a method of capturing a target species at a wellsite, comprising: receiving an exhaust gas stream from an engine of a pumping unit; removing particulates from the exhaust gas; cooling the exhaust gas stream; removing water from the cooled exhaust gas stream and directing the dry exhaust gas stream to a species capture unit; removing a target species from the dry gas exhaust stream with the species capture unit by percolating the dry gas exhaust gas stream through a liquid target species capturing media to create a ladened liquid target species capturing media; flowing the ladened liquid target species capturing media to a regenerator; desorbing the target species from the ladened liquid target species capturing media by increasing the temperature of the ladened liquid target species capturing media; cooling the desorbed target species; compressing the desorbed target species; and storing the desorbed target species.

### BRIEF DESCRIPTION OF DRAWINGS

The appended figures illustrate only exemplary embodiments and are therefore not to be considered limiting of the scope of the disclosure, as the disclosure may admit to other equally effective embodiments.

FIG. 1 is an exemplary workflow for decarbonization of reservoir stimulation operation at the wellsite, according to one or more embodiments of the disclosure.

FIG. 2 is an exemplary wellsite with a carbon capture system, according to one or more embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

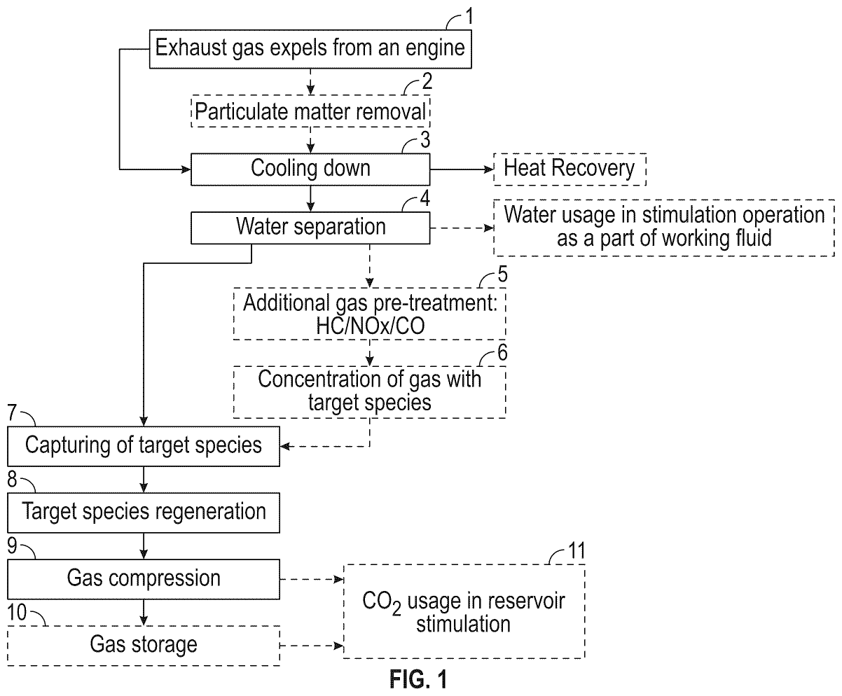

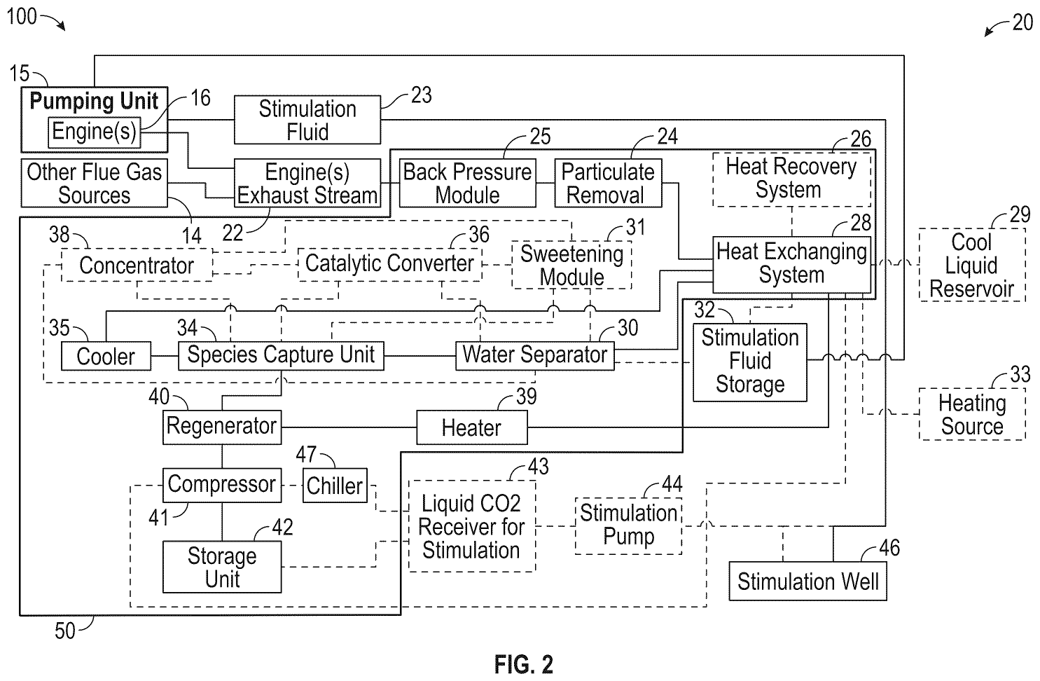

The present disclosure is directed in general to carbon capture systems at a wellsite 100. FIG. 1 illustrates an exemplary workflow (e.g., Stages) for decarbonization of reservoir stimulation operation at the wellsite 100. Dashed lines within the FIG. 1 correspond to optional stages. FIG. 2 illustrates exemplary carbon capture system 20 to complete the workflow shown in FIG. 1. FIG. 2 similarly shows optional features in dashed lines.

The wellsite 100 includes one or more pumping units 15 configured to pump a stimulation fluid 23 (e.g., fracking fluid) into a stimulation well 46. The pumping units 15 include one or more engines 16 to drive the pumps to pump the stimulation fluid 23. The one or more engines 16 create an exhaust stream 22 that is input into the carbon capture system 20. Additional flue gas sources 14, such as auxiliary pumps and other engines, may be present at the wellsite 100. The flue gas from the flue gas sources 14 may also be directed into the carbon capture system 20 along with the exhaust stream 22 of the one or more engines 16.

The carbon capture system 20 is configured for the capture of at least one a target species, such as carbon dioxide (CO₂). The carbon capture system 20 may include, a back pressure module 25, a particulate removal system 24, a heat exchanging system 28, a water separator 30, a capture unit 34, a cooler 35, a heater 39, a regenerator 40, a compressor 41, a storage unit 42, and chiller 47. The carbon capture system 20 may also include, a heat recovery system 26, a sweetening module 31, a concentrator 38, and a catalytic converter 36. The target specie(s) may be, but are not limited to, carbon dioxide.

In a Stage 1 (identified by reference sign 1), the exhaust stream 22 is expelled from the one or more engines 16 through a suitable exhaust system. The one or more engines 16 generate sufficient pressure a flow rate sufficient for hydraulic fracturing operations. In an embodiment, the carbon capture system 20 is designed such that system 20 may be connected to an exhaust stream 22 of the one or more engines 16 that are utilized as the power source of the pumping unit 15. The pumping unit 15 may be one or more fracturing pumps and auxiliary equipment.

The exhaust gas flow rate from the engine(s) 16 may be influenced by multiple factors, such as engine size and type, fuel type and quality, engine load, fuel destruction efficiency, engine operating conditions (such as engine speed, temperature and altitude) and exhaust system design. In a non-limiting example, a diesel engine prime mover for hydraulic pumping and classified by the US Environmental Protection Agency (EPA) as Tier 1 may generate about 1,338 cubic feet per minute at an engine speed of 650 revolutions per minute (rpm) and about 12,583 cubic feet per minute at an engine speed of 1900 rpm.

The constituents of the exhaust stream 22 may contain all or a portion of the following including carbon dioxide (CO₂), water (H₂O), nitrogen (N₂), nitrogen oxides, carbon monoxide (CO), oxygen (O₂), hydrocarbons, particulate matter, sulfur containing molecules and/or other species. The temperature of the engine(s) exhaust stream 22 exiting the one or more engines 16 may be up to about 800° C.

In an embodiment, the exhaust gas stream 22 may be generated by a single engine 16. In an embodiment, the exhaust gas stream 22 may be generated by multiple engines 16. The exhaust gas stream 22 may be generated by a combination of all engine units 16 at a given site or the exhaust gas stream 22 may be generated by a subset of all the engine units 16 at a given site. The engines 16 may be utilized as a prime mover for the pumping units 15 to pump stimulation fluid 23 to a well 46 for stimulation (e.g., fracturing) thereof, as will be appreciated by those skilled in the art.

In a Stage 2, which is identified by reference sign 2, particulate matter may be optionally removed from the exhaust stream 22 utilizing a particulate removal system 24, such as a diesel particulate filter or similar device. Particulate matter in the exhaust stream 22 results from incomplete combustion of a fuel. In some embodiments, the particulate removal could be completed by a recirculated liquid wash vessel. In some embodiments, the particulate matter removal system 24 may include diesel particulate filters such as those utilized in the automotive industry, such as Dry Particulate Filters (DPF) and moisture-type Filters à Particules (FAP). DPFs can be single-use systems intended for disposal and replacement once they are full of accumulated particles, or they can be designed to burn off the accumulated particles. DPFs may be, but are not limited to, cordierite wall flow filters, silicon carbide flow filters, ceramic fiber filters, metal fiber filters, or other applicable types. FAPs use special liquids, such as Infineum, Eolys, or other applicable liquids added to the filter, to reduce the temperature required for afterburning. As a result, the self-healing of the filter becomes more efficient during operation, although regular replenishment of the applicable fluid is necessary. Another applicable filter is FAP with fuel injection to reduce consumption of special fluids for afterburning.

In some embodiments, the particulate removal system 24 may be configured specifically servicing diesel engines. These systems include but are not limited to Duplex Filtration Systems, Continuous Regeneration Traps (CRT), CRT with catalyzers, Selective Catalytic Reduction Traps (SCRT), and carbamide ammonium SCRs (SCR-AC), or any other developed systems or systems known to those skilled in the art. In an embodiment(s), electrostatic separators may be utilized as a particulate filter.

To minimize the number of filter units with the particulate removal system 24 and/or to combine the cleaning of combustion products from several wellsite sources, industrial filters may be utilized. These filters may be, but are not limited to, cyclones, sleeve filters, fluid-based or foam filters, electrostatic filters. Fluid-based scrubbers can be bubble absorbers, venturi scrubbers, stationary packed columns, and fluidized bed scrubbers, and may utilize water, water mixtures, or any other suitable liquids. Such particulate removal systems 24 can combine the functions of several equipment elements, such as particular matter filters, heat exchanging system, sweetening devices, or any other device suitable for extracting undesirable chemicals from combustion products. At the same time, fracturing liquid may be used as a fluid agent in these systems with its further injection to the wellbore or storage in a low-pressure vessel for subsequent disposal.

The particulate matter removal system 24 may comprise a single filter or may be a plurality and/or combination of several filters of different or the same types arranged in series or in parallel.

Stage 2 also additionally includes regulating the backpressure of the one or more engines 21. The carbon capture system 20 may operate at pressures that are not ideal for operation of the one more engines. A backpressure module 25 is coupled to the exhaust of the one or more engines 21 to regulate the backpressure. For example, the backpressure module may be a blower. In some embodiments, the blower can be placed downstream of cooling (e.g., cooler 35) or separation units (e.g., water separator 30, hydrocarbon separation unit) to reduce power consumption due to smaller applied flow volumes. In these scenarios a vacuum is created in order to generate the required pressure drop profiles.

In a Stage 3, which is identified by reference sign 3, the exhaust gas stream 22 is cooled. Stage 3 may optionally include using the heat from the exhaust gas stream 22 to operate other components of the carbon capture system 20. The gas exhaust stream 22 passes through a heat exchanging system 28 where the stream 22 is cooled. The heat exchanging system 28 cools the exhaust gas stream 22 to a target temperature, such as below a water dewpoint temperature of the exhaust stream 22 to facilitate water separation in the water separator 30 (e.g., water separation unit). The heat exchanging system 28 may utilize a cooler 35 (e.g., cooling system, cooling unit) and/or liquid cooling source cool water reservoir 29 such as such as river, lake, sea, ponds or batch mixers, water tanks, chemicals tanks, hydrocarbon storage/separation units, or combinations thereof, to cool the exhaust stream 22. The heat exchanging system 28 may comprise of at least one heat exchanger, a thermal regulator unit for controlling the flow(s) from cooling and heating source(s) and/or exhaust gas stream 22 therethrough, such as to maintain a predetermined outlet temperature exhaust gas stream 22 or the like. A heat recovery system 26 (e.g., heat recovery unit) may be coupled to or integral with the heat exchanging system 28 to recover the heat of the exhaust gas stream 22. For example, the heat recovery system 26 may utilize a Rankine cycle to convert the heat energy to mechanical energy. The heat recovered from the exhaust gas stream 22 can be used for, but not limited to target species desorption in regenerator 40 (e.g., regeneration unit), temperature control of a capture unit 34 (e.g., target species capturing unit, species capturing module), and/or powering one or more components, such as a compressor 41. For example, the heat exchanging system 28 and heat recovery system 26 may be a boiler assembly used to supply a heated fluid (e.g., heated water, steam) to the heater 39 (e.g., heating system) to facilitate regeneration of the target species in the regenerator 40.

In a Stage 4, which is identified by reference sign 4, liquid and/or water is removed from the exhaust stream 22 utilizing a water separator 30 to dry the exhaust stream 22. The water separator 30 may include a sodium hydroxide wash scrubber to remove the water. After the dry exhaust stream 22 is cooled down to a predetermined temperature in the heat exchanging system 28 noted in Stage 3, the exhaust stream 22 is routed to the separator 30 to be separated into a gas component and water. Water captured from the exhaust stream 22 may or may not be stored in a storage facility or area 32 and further used in formulating a stimulation fluid (e.g., fracturing fluid). The separator 30 may utilize additional drying techniques to remove water and other liquids from the exhaust stream 22. For example, the water separator 30 water may include adsorbent materials such as, but not limited to, proppant, to remove water and other liquids from the exhaust stream 22. The dry exhaust stream 22 is then routed for further processing.

In a Stage 5, which is identified by reference sign 5, the exhaust gas stream 22 is routed to an optional gas pre-treatment such as a catalytic converter 36 (e.g., catalytic conversion unit) in order to reduce a concentration of undesired constituents within the exhaust stream 22. Such undesired constituents may comprise unburned hydrocarbons (HC), nitrogen oxides (NOx) and carbon monoxide (CO). The concentration of undesired constituents may be reduced by routing the exhaust gas stream through the catalytic converter 36 or similar selective catalytic reduction system. In some embodiments, the sweetening module/unit 31 may be utilized whereby the exhaust stream 22 is routed from the outlet of the water separator 30 to the sweetening module 31 prior to introducing the exhaust stream 22 into the catalytic converter 36. The sweetening module 31 may advantageously reduce sulfur-containing components from the exhaust stream 22 and thereby increase the life of catalytic converter 36 and the species capture unit 34.

In a Stage 6, which is identified by reference sign 6, the exhaust gas stream 22 may be routed from the catalytic converter 36 and/or the sweetening module 31 through a concentrator 38 (e.g., concentrator system, concentrator unit) to increase the concentration of the target species (carbon dioxide for example) within the exhaust stream in order to increase the overall efficiency of carbon capture within the carbon capture system 20. In some embodiments, the concentrator 38 may include one or more subunits arranged sequentially to increase the concentration of the target species. For example, a sequential arrangement could include an adsorbent carbon capture unit followed by a membrane carbon capture unit. Such an arrangement minimizes the footprint of the system 20 and increases the concentration of carbon dioxide in the stream 22 before the capture unit 34 or membrane, allowing for more effective operation.

In a Stage 7, which is identified by reference sign 7, the target species (e.g., CO₂) is captured by the species capture unit 34. The cooler 35 is in communication with the heat exchanging system 28, such as using the heat exchanging system 28 to cool down the cooling fluid and/or cooling as used by the cooler 35. In some embodiments, the species capture unit 34 is a solids-based (e.g., particulate) absorption unit. In some embodiments, the species capture unit 34 is a liquid-based (e.g., solvent) absorption unit. The species capture unit 34 is configured and/or designed such that the unit 34 captures from about 0 to about 99% of the target species contained within the exhaust stream.

A solids-based absorption unit uses a solid target species capturing media, such as zeolite, modified zeolite, metal organic frameworks, or any other solid target species capturing media. The solid target species capturing media absorbs the target species (CO₂) at a first temperature range and desorbs the target species when heated to a second temperature range. The solid target species capturing media may be repeatedly cooled to capture the target species and then heated to release the target species. For example, the solid target species capturing media within the capture unit 34 may be cooled by cooler 35 to the first temperature range at Stage 7 to absorb the target species. The temperature of the solid target species capturing media within the capture unit 34 may be increased to the second temperature range by the heater 39 at Stage 8 to desorb the target species. In some embodiments, either pressure or electric charge differences could be used to absorb and desorb the target species instead of temperature swings.

A liquids-based absorption unit uses one or more absorption towers that include a liquid target species capturing media, such as an amine based media or other suitable liquid media. For example, the liquid target species capturing media may be monocthalolamine (MEA), diethalolamine (DEA), triethanol amine (TEA), and piperazine. The liquid target species capturing media absorbs the target species at a first temperature range and desorbs the target media when heated to a second temperature range. For example, the exhaust gas stream 22 may be introduced into the one or more absorption towers of the capture unit 34 at Stage 7. The exhaust gas stream 22 percolates through the liquid target species capturing media to facilitate the absorption of the target species. The liquid target species capturing media ladened with the target species is sent (e.g., flowed) to the regeneration unit to be heated at Stage 8 to desorb the captured target media. A residual portion of the exhaust gas stream 22 entering the one or more absorption towers that did not get absorbed exits the one or more absorption towers. The remaining exhaust gas stream 22 then enters into a wash column treats the residual portion to remove liquid target species capturing media that intermixed (e.g. vaporized) with the exhaust gas stream 22. The portion exits the wash column and is then directed to a compressor or released into the atmosphere. In some embodiments, the portion exiting the wash column has the oxygen and/or other removed prior to being used elsewhere at the wellsite, such as being injected into the wellbore. Liquid target species capturing media recovered from the exhaust gas stream 22 is then recirculated to the one or more absorption towers.

In some embodiments, the one or more absorption towers are arranged in series. In some embodiments, and as discussed herein, the species capture unit 34 is part of a mobile carbon capture system 20. The one or more absorption towers are sized to be transported via road to avoid collision with overpasses and the like.

In a Stage 8, which is identified by reference sign 8, the target species (CO₂) captured by the capture unit 34 is subjected to regeneration process in a regenerator 40 to release the target species. The heater 39 may heated by the heat exchanging system 28 and/or heat recovery unit 26. In some embodiments, the heater 39 may use a heating source 33 such as produced water, waste heat from an engine(s), a nearby geothermal well, heat obtained by photovoltaic or concentrated solar energy, burning of hydrocarbons, and/or waste burning to as a source of heat. In some embodiments, the heater 39 may use the heating source 33 in combination with the heat exchanging system 28 and/or heat recovery unit 26. In some embodiments, the heater 39 uses the heat of the exhaust gas stream 22, via the heat recovery unit 26, to facilitate desorption.

For example, in a solids-based absorption unit, solid target species capturing media is heated up by the heater 39 to allow the captured CO₂ or any other target species to desorb. As another example where the capture unit 34 is a liquids-based capture unit, the heater 39 raises the temperature of the liquid target species capturing media within one or more desorption towers to allow the captured CO2 or any other target species to desorb. Once desorption is complete, the liquid target species capturing media is allowed to cool, such as being cooled by the cooler 35, and reintroduced into the one or more absorption towers for additional absorption. In some embodiments, the one or more desorption towers are sized to facilitate transportation of the capture unit 34 on roads.

In a Stage 9, which is identified by reference sign 9, the regenerated CO₂ is compressed and therefore liquified by at least one compressor 41. The at least one compressors 41 are a target species compression module for liquefying the target species. The at least one compressor 41 may be, but is not limited to, a rotary screw compressor, a reciprocating compressor, a combination thereof, or the like. The prime mover of the compressor 41 for the CO₂ compression and liquefication may be from any suitable source of mechanical power including, but not limited to, mechanical power generated by heat recovery system 26 or any other power source.

In an embodiment, the at least one compressor 41 is in communication with the heat exchanging system 28 to enable cooling of the gas being compressed by compressor 41 to enable gas liquefaction. In some embodiments, the compressed target species exiting the at least one compressor 41 may be cooled by the chiller 47 to facilitate liquefaction.

After the CO₂ is liquified by the compressor 41, in a Stage 10 (which is identified by reference sign 10), the liquified CO₂ is optionally routed to a storage unit 42. In some embodiments, the CO₂ is liquified after being cooled by chiller 47. In some embodiments, the target species compression module includes the at least one compressor 41 and chiller 47. For example, the target species compression module include a plurality of compressors 41 in series with a plurality of inline chillers 47 configured to reduce the temperature of the carbon dioxide as the carbon dioxide is liquified.

The storage unit 42 may be a tank to store regenerated and liquified CO₂ gas. The storage unit 42 may be mounted to the same truck and/or skid together with other units/modules 24, 25, 26, 28, 30, 31, 34, 35, 36, 38, 39, 40, 41 and/or 47 of the carbon capture system 20 for capturing of targeted species or the storage unit 42 may be located on separate truck. For example, FIG. 2 shows the modules 24, 25, 26, 28, 30, 31, 34, 35, 36, 38, 39, 40, 41 and 47 of the carbon capture system 20 disposed on a mobile platform 50 to facilitate movement of the carbon capture system 20 to the wellsite 100. The mobile platform 50 may be, for example, a trailer, a tandem trailer, a solid body, a skid, or a chassis.

In a stage 11, which is identified by reference sign 11, CO₂ captured in the process of reservoir stimulation can be used as an additive to stimulation fluid. The storage unit 42 may be in communication with a fluid receiver 43 for stimulation fluid, which may then be routed to a stimulation pump(s) 44 (which may or may not be powered by engines 16) and then to a well 46 and/or combined with fluid in storage 32. CO₂ dissolved in water forms energized fluid that facilitates stimulation fluid flowback and hydrocarbons flow. In some of the cases application of CO₂ containing fluid, such as foams or energized fluids, is required for reservoir stimulation.

Equipment of the system 20 for decarbonization of reservoir stimulation operations may be installed on each pumping unit 15 utilized in the hydraulic fracturing or, alternatively, can be centralized connecting all pumping units 15 used for hydraulic fracturing. The size and weight of the equipment of the system 20 for stimulation decarbonization is able to be transported on a single solid body and/or skid, a trailer or combination of trailers, tandem trailers, or any combination of multiple units. The carbon capture system 20 may therefore be advantageously able to be moved between various wellsites along with or separately, such as on mobile platform 50, from various fracturing surface equipment including the engines 16, thereby providing a system 20 that is independent of the engines 16.

In some embodiments, the system 20 is configured to handle rapid engine 16 transient load fluctuations and to handle flue gas flow rates 22 from all engines on the wellsite.

In some embodiments, the carbon capture system 20 may be mobile in which the components of the carbon capture system 20 are mounted to a trailer chassis or skid based able to be transported on a solid body, trailer, or combination of trailers, tandem trailers, or any combination of multiple units. In some embodiments, this kind of mobile carbon capture system 20 is centralized such that that the mobile carbon capture system 20 is designed to capture target species from one or several engines 16 of several pumping units 15 used for hydraulic fracturing, serving as a mini plant for carbon capture from reservoir stimulation operation. In some embodiments, the well site for the oilfield operation, such as a fracturing operation, may require a mobile carbon capture system 20 for each pumping unit 15. In some embodiments, multiple carbon capture systems 20 are required for each pumping unit 15, such as each engine 16 or multiple engines of each pumping unit 15 being connected to separate mobile carbon capture systems 20.

Alternatively, the system 20 for target species capture can be mounted to the pumping unit. It can be installed in proximity to the pumping unit engine 16.

The operation of the system 20 may be advantageously monitored using suitable sensors and/or measurement devices. The operation of the system 20 may be controlled and/or processed utilizing a suitable controller, computer, or the like. The operation of the system 20 may further be optimized utilizing machine learning algorithms, artificial intelligence algorithms, or the like.

### EXAMPLE ASPECTS

Implementation examples are described in the following numbered aspects:

Aspect 1: A system for capturing a target species from an exhaust gas stream generated by at least one engine at a surface of a wellbore utilized in reservoir stimulation for subsurface energy recovery, comprising: a heat exchanging system for cooling the exhaust gas stream to a predetermined temperature; a water separation unit for separating a liquid from the cooled exhaust gas stream; a target species capture module for capturing the target species from the cooled exhaust gas stream; a target species regeneration module to extract the captured target species; a target species compression module for liquefying the captured target species; and a target species storage module for storing the liquified target species, wherein the system is mounted on a mobile platform for transportation to and from the surface of the wellbore.

Aspect 2: The system of Aspect 1 wherein the cooled exhaust stream is treated with a particulate matter removal system prior to being routed to the target species capturing module.

Aspect 3: The system of any combination of Aspects 1-2 wherein the cooled exhaust stream is treated with a sweetening module prior to being routed to the target species capturing module.

Aspect 4: The system of any combination of Aspects 1-3, wherein the cooled exhaust stream is treated with a catalytic converter prior to being routed to the target species capturing module.

Aspect 5: The system of any combination of Aspects 1-4, wherein the cooled exhaust stream is concentrated with target species before entering the target species capturing module.

Aspect 6: The system of any combination of Aspects 1-5, further comprising a backpressure regulation module coupled to the exhaust of the one or more engines.

Aspect 7: The system of any combination of Aspects 1-6, wherein the target species capture module includes a solid target species capturing media.

Aspect 8: The system of Aspect 7, wherein the solid target species capturing media is zeolite.

Aspect 9: The system of any combination of Aspects 1-6, wherein the target species capture module includes a liquid target species capturing media.

Aspect 10: The system of Aspect 9, wherein the target species capture module includes a plurality of absorption towers arranged in series, and the liquid target species capturing media is disposed in the absorption towers.

Aspect 11: The system of any combination of Aspects 9-10, wherein the liquid target species capturing media is at least one of monoethalolamine (MEA), diethalolamine (DEA), triethanol amine (TEA), or piperazine.

Aspect 12: The system of any combination of Aspects 1-11, where target species capture system is installed on a pumping unit.

Aspect 13: The system of any combination of Aspects 1-12, wherein the mobile platform is at least one of a chassis, a skid, a trailer, or a tandem trailer.

Aspect 14: A method of capturing a target species at a wellsite, comprising: receiving an exhaust gas stream from an engine of a pumping unit; removing particulates from the exhaust gas; cooling the exhaust gas stream; removing water from the cooled exhaust gas stream and directing the dry exhaust gas stream to a species capture unit; removing a target species from the dry gas exhaust stream with the species capture unit by percolating the dry gas exhaust gas stream through a liquid target species capturing media to create a ladened liquid target species capturing media; flowing the ladened liquid target species capturing media to a regenerator; desorbing the target species from the ladened liquid target species capturing media by increasing the temperature of the ladened liquid target species capturing media; cooling the desorbed target species; compressing the desorbed target species; and storing the desorbed target species.

Aspect 15: The method of Aspect 14, wherein cooling the exhaust gas stream includes recovering heat from the exhaust gas stream, and wherein the recovered heat is used to increase the temperature of the ladened liquid target species capturing media.

Aspect 16: The method of any combination of Aspects 14-15, further comprising regulating a backpressure to the engine using a blower.

Aspect 17: The method of any combination of Aspects 14-16, wherein the liquid target species capturing media is selected from at least one of monoethalolamine (MEA), diethalolamine (DEA), triethanol amine (TEA), or piperazine.

Aspect 18: The method of any combination of Aspects 14-17, wherein a residual portion of the exhaust gas stream exits that is not absorbed by the liquid target species capturing media is treated in a wash column to remove the liquid target species capturing media from the residual portion.

Aspect 19: The method of any combination of Aspects 14-18, further comprising liquefying the target species.

Aspect 20: The method of any combination of Aspects 14-19, further comprising injecting the target species into a wellbore after liquefying the target species.

The preceding description has been presented with reference to present embodiments. Persons skilled in the art and technology to which this disclosure pertains will appreciate hat alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

It is contemplated that any one or more elements or features of any one disclosed embodiment or example may be beneficially incorporated in any one or more other non-mutually exclusive embodiments or examples. While the foregoing is directed to embodiments of the present disclosure, other and further embodiments of the disclosure may be devised without departing from the basic scope thereof, and the scope thereof is determined by the claims that follow.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for capturing a target species from an exhaust gas stream generated by at least one engine at a surface of a wellbore utilized in reservoir stimulation for subsurface energy recovery, comprising:
a heat exchanging system for cooling the exhaust gas stream to a predetermined temperature;
a water separation unit for separating a liquid from the cooled exhaust gas stream;
a target species capture module for capturing the target species from the cooled exhaust gas stream;
a target species regeneration module to extract the captured target species;
a target species compression module for liquefying the captured target species; and
a target species storage module for storing the liquified target species, wherein the system is mounted on a mobile platform for transportation to and from the surface of the wellbore.

2. The system of claim 1 wherein the cooled exhaust stream is treated with a particulate matter removal system prior to being routed to the target species capturing module.

3. The system of claim 1 wherein the cooled exhaust stream is treated with a sweetening module prior to being routed to the target species capturing module.

4. The system of claim 1, wherein the cooled exhaust stream is treated with a catalytic converter prior to being routed to the target species capturing module.

5. The system of claim 1, wherein the cooled exhaust stream is concentrated with target species before entering the target species capturing module.

6. The system of claim 1, further comprising a backpressure regulation module coupled to the exhaust of the one or more engines.

7. The system of claim 1, wherein the target species capture module includes a solid target species capturing media.

8. The system of claim 7, wherein the solid target species capturing media is zeolite.

9. The system of claim 1, wherein the target species capture module includes a liquid target species capturing media.

10. The system of claim 9, wherein the target species capture module includes a plurality of absorption towers arranged in series, and the liquid target species capturing media is disposed in the absorption towers.

11. The system of claim 9, wherein the liquid target species capturing media is at least one of monoethalolamine (MEA), diethalolamine (DEA), triethanol amine (TEA), or piperazine.

12. The system of claim 1, wherein the target species capture system is installed on a pumping unit.

13. The system of claim 1, wherein the mobile platform is at least one of a chassis, a skid, a trailer, or a tandem trailer.

14. A method of capturing a target species at a wellsite, comprising:
receiving an exhaust gas stream from an engine of a pumping unit;
removing particulates from the exhaust gas;
cooling the exhaust gas stream;
removing water from the cooled exhaust gas stream and directing the dry exhaust gas stream to a species capture unit;
removing a target species from the dry gas exhaust stream with the species capture unit by percolating the dry gas exhaust gas stream through a liquid target species capturing media to create a ladened liquid target species capturing media;
flowing the ladened liquid target species capturing media to a regenerator;
desorbing the target species from the ladened liquid target species capturing media by increasing the temperature of the ladened liquid target species capturing media;
cooling the desorbed target species;
compressing the desorbed target species; and
storing the desorbed target species.

15. The method of claim 14, wherein cooling the exhaust gas stream includes recovering heat from the exhaust gas stream, and wherein the recovered heat is used to increase the temperature of the ladened liquid target species capturing media.

16. The method of claim 14, further comprising regulating a backpressure to the engine using a blower.

17. The method of claim 14, wherein the liquid target species capturing media is selected from at least one of monoethalolamine (MEA), diethalolamine (DEA), triethanol amine (TEA), or piperazine.

18. The method of claim 14, wherein a residual portion of the exhaust gas stream exits that is not absorbed by the liquid target species capturing media is treated in a wash column to remove the liquid target species capturing media from the residual portion.

19. The method of claim 14, further comprising liquefying the target species.

20. The method of claim 19, further comprising injecting the target species into a wellbore after liquefying the target species.
